(19) United States
(12) Patent Application Publication
(10) Pub. No.: US 2016/0116958 A1
(43) Pub. Date: Apr. 28, 2016

(54) DELAY SYSTEM FOR DELAYING SHUTDOWN OF SERVER

(71) Applicants: HONG FU JIN PRECISION INDUSTRY (ShenZhen) CO., LTD ., Shenzhen (CN); HON HAI PRECISION INDUSTRY CO., LTD., New Taipei (TW)

(72) Inventor: MING YU, Shenzhen (CN)

(21) Appl. No.: 14/524,117

(22) Filed: Oct. 27, 2014

(51) Int. Cl. G06F 1/30

(52) U.S. Cl. CPC G06F 1/30

(57) ABSTRACT

A system for delaying shutdown of a server is provided. The server includes a data processing unit connected to an external power supply unit. The system includes a delay controlling unit and a discharging unit. The delay controlling unit is switched on to connect the data processing unit to the external power supply unit, so that the external power supply supplies power for the data processing unit. When shut down, the delay controlling unit is switched off, so that the discharging unit discharges to continue supplying power to the data processing unit for a predetermined time period.

### FIELD

The disclosure generally relates to delay systems, and particularly relates to a delay system applied to a server.

### BACKGROUND

A blade server may have a power supply unit, a plurality of servers, and a plurality of other loads, such as fans. The power supply unit is connected to the plurality of servers and the plurality of loads, for providing power for the servers and the plurality of loads.

### BRIEF DESCRIPTION OF THE DRAWINGS

Many aspects of the embodiments herein can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of an electronic device.

FIG. 2 is another block diagram of the electronic device of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.” The references “a plurality of” and “a number of” mean “at least two.” In the following disclosure the term “coupled” is defined as connected, whether directly or indirectly through intervening components, and is not necessarily limited to physical connections. The connection can be such that the objects are permanently connected or releasably connected.

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

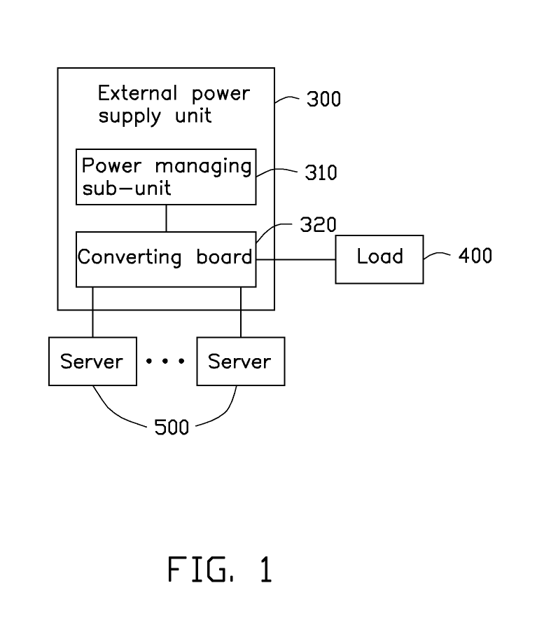

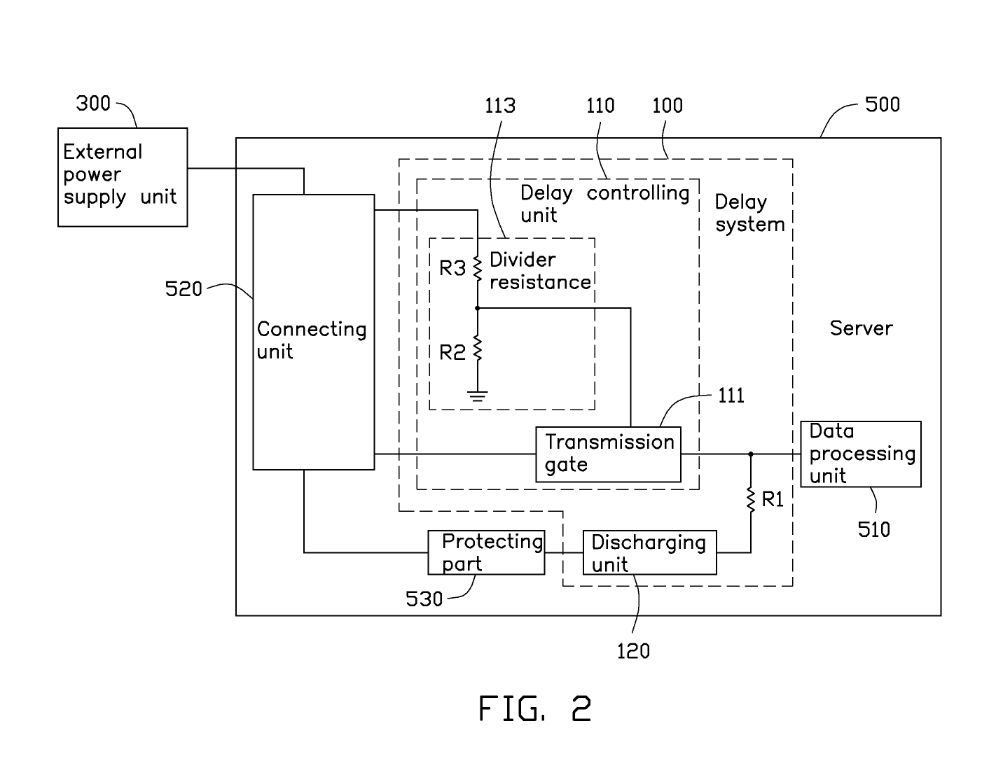

FIGS. 1 and 2 illustrate an electronic device. The electronic device can include an external power supply unit 300, a plurality of servers 500, and a load 400. A delay system 100 can be located in each of the plurality of servers 500.

The external power supply unit 300 includes a power managing sub-unit 310, and a converting board 320 coupled to the power managing sub-unit 310. The converting board 320 is connected to the load 400 and the plurality of servers 500. The power managing sub-unit 310 supplies power for the servers 500 and the load 400. The load 400 can be fans or other loads.

Each server 500 further includes a data processing unit 510, a connecting unit 520, and a protecting part 530. The connecting unit 520 is coupled to the converting board 320 and the delay system 100. The delay system 100 is coupled to the data processing unit 510 and can continue supplying power for the data processing unit 510 when the external power supply unit 300 stops supplying power to the data processing unit 510. The protecting part 530 is coupled to the connecting unit 520 and the data processing unit 510.

The delay system 100 includes a delay controlling unit 110 and a discharging unit 120. The discharging unit 120 is coupled to the data processing unit 510 and the delay controlling unit 110 via a resistor R1 . In at least one embodiment, the discharging unit 120 is a rectifier.

The delay controlling unit 110 includes a transmission gate 111 and a divider resistance 113. The transmission gate 111 is coupled to the connecting unit 520, the resistor R1, and the data processing unit 510. The divider resistance 113 includes a second resistor R2 and a third resistor R3. A first end of the second resistor R2 is coupled to a first end of the third resistor R3 and the transmission gate 111, and a second end of the second resistor R2 is grounded. A second end of the third resistor R3 is connected to the connecting unit 520. The discharging unit 120 is connected to the connecting unit 520 via a protecting part 530.

When the external power supply unit 300 operates, the transmission gate 111 is switched on so that the power supply unit 300 supplies power to the data processing unit 510.

When the external power supply unit 300 stops supplying power to the server 500, the transmission gate 111 is switched off to disconnect the connecting unit 520 from the data processing unit 510. When the transmission gate 111 is switched off, the discharging unit 120 can discharge to supply power for the data processing unit 510 for a predetermined time period. Thus, the data processing unit 510 can store data in a buffering process.

Certain steps or methods described herein can be removed, others can be added, and the sequence of steps can be altered. The description and the claims drawn for or in relation to a method may give some indication in reference to certain steps. However, any indication given is only to be viewed for identification purposes, and is not necessarily a suggestion as to an order for the steps.

The embodiments described herein are illustrative, and should not be construed as limiting the following claims.

What is claimed is:

1. A delay system for delaying shutdown of a server, the server comprising a data processing unit connected to an external power supply unit, the external power supply unit configured to supply power for the data processing unit, and the delay system comprising:
a delay controlling unit configured to be switched on to connect the data processing unit with the external power supply unit when the external power supply unit supplies power for the data processing unit; and
a discharging unit coupled to the delay controlling unit and configured to be coupled to the external power supply unit,
wherein the delaying controlling unit is switched off to disconnect the external power unit when the external power supply unit stops supplying power for the data processing unit, and the discharging unit is configured to discharge to supply power for the data processing unit.

2. The delay system of claim 1, wherein the delay controlling unit comprises a transmission gate, and the transmission gate is coupled to the external power supply unit and the data processing unit.

3. The delay system of claim 2, wherein the transmission gate is switched on to connect the external power supply unit with the data processing unit when the external power supply supplies power for the data processing unit, and the transmission gate is switched off when the external power supply unit stops to supply power for the data processing unit.

4. The delay system of claim 2, wherein the discharging unit is coupled to the transmission gate and the data processing unit via a first resistor.

5. The delay system of claim 2, wherein the delay controlling unit further comprises a divider resistance, and the divider resistance is coupled to the external power supply unit and the data processing unit.

6. The delay system of claim 5, wherein the divider resistance comprises a second resistor and a third resistor, a first end of the second resistor is coupled to the transmission gate and the first end of the third resistor, the second end of the second resistor is grounded, and a second end of the third resistor is connected to the external power supply unit.

7. An electronic device comprising:
a server comprising a data processing unit;
an external power supply unit configured to provide power to the data processing unit; and
a delay system including:
a delay controlling unit configured to be switched on to connect the data processing unit with the external power supply unit when the external power supply unit supplies power for the data processing unit; and
a discharging unit coupled to the delay controlling unit and configured to be coupled to the external power supply unit,
wherein the delaying controlling unit is switched off to disconnect the external power unit when the external power supply unit stops to supply power for the data processing unit, and the discharging unit is configured to discharge to supply power for the data processing unit.

8. The electronic device of claim 7, wherein the server further comprises a connecting unit coupled to the external power supply, the delay controlling unit comprises a transmission gate, and the transmission gate is coupled to the connecting unit and the data processing unit.

9. The electronic device of claim 8, wherein the transmission gate is switched on when the external power supply supplies power for the data processing unit, and the transmission gate is switched off when the external power supply unit stops to supply power for the data processing unit.

10. The electronic device of claim 8, wherein the discharging unit is coupled to the transmission gate and the data processing unit via a first resistor.

11. The electronic device of claim 8, wherein the delay controlling unit further comprises a divider resistance, and the divider resistance is coupled to the connecting unit and the data processing unit.

12. The electronic device of claim 11, wherein the divider resistance comprises a second resistor and a third resistor, a first end of the second resistor is coupled to the transmission gate and the first end of the third resistor, the second end of the second resistor is grounded, and a second end of the third resistor is connected to the external power supply unit.

13. The electronic device of claim 11, wherein the server further comprises a protecting part, the discharging unit is coupled to the connecting part via the protecting part.

14. The electronic device of claim 7, wherein the discharging unit is a rectifier.
